(19) United States
(12) Patent Application Publication
(10) Pub. No.: US 2016/0180784 A1
(43) Pub. Date: Jun. 23, 2016

(54) LIQUID CRYSTAL DISPLAY PANEL AND LIQUID CRYSTAL DISPLAY DEVICE

(71) Applicant: SHENZHEN CHINA STAR OPTOELECTRONICS TECHNOLOGY CO. LTD., Shenzhen, Guangdong (CN)

(72) Inventor: Feng ZHAO, Shenzhen, Guangdong (CN)

(21) Appl. No.: 14/416,571

(22) PCT Filed: Dec. 24, 2014
(86) PCT No.: PCT/CN2014/094760

§ 371 Date: Jan. 22, 2015

(30) Foreign Application Priority Data
Dec. 18, 2014 (CN) 201410790091.3

(51) Int. Cl. G09G 3/36

(52) U.S. Cl. CPC G09G 3/3614; G09G 3/3696; G09G 3/3648; G09G 2300/0426; G09G 2310/0202; G09G 2330/021

(57) ABSTRACT

The present invention provides a liquid crystal display panel and device. The display panel comprises a common electrode. The common electrode comprises a first sub electrode comprising first branch portions corresponding to the (2k+1)th row or the (2k+1)th column of pixel electrodes in a pixel electrode matrix; and a second sub electrode opposite to the first sub electrode, the second sub electrode comprising second branch portions corresponding to the (2k)th row or the (2k)th column of the pixel electrodes in the pixel electrode matrix.

### BACKGROUND OF THE INVENTION

1. Field of the Invention

The present invention relates to a display technology, and more particularly, to a liquid crystal display panel and a liquid crystal display device.

2. Description of Prior Art

When a liquid crystal display (LCD) drives pixels, an alternative driving is adopted to avoid forming a polarized electric field. For the alternative driving, the voltage (e.g., 7V in general) inputted to a common electrode is usually constant and the voltage inputted to a pixel electrode is alternatively changed such that an absolute value of a voltage difference between an upper substrate and a lower substrate of a display panel maintains constant. Specifically, during driving the pixels, the voltage difference between the former image frame and the later image frame in the image data inputted to the display panel is changed with positive polarity and negative polarity. Therefore, when the voltage inputted to the common electrode is 7V approximately, the voltage inputted to the pixel electrode requires to be changed between 0V to 14V. It is not difficult to see the voltage inputted to the pixel electrode is at least twice the voltage of the common electrode, thereby increasing the power consumption.

Therefore, it is necessary to provide a liquid crystal display panel and a liquid crystal display device for solving the problems existed in the convention skills.

### SUMMARY OF THE INVENTION

The objective of the present invention is to provide a liquid crystal display panel and a liquid crystal display device, for solving the problem of the voltage inputted to pixel electrodes required to be increased in conventional display panels, thereby increasing the power consumption.

To solve above problems, the technical schemes of the present invention are provided below.

The embodiments of the present invention provides a liquid crystal display panel, comprising: a first substrate comprising data lines, scan lines, and a pixel electrode matrix defined by the data lines and the scan lines; and a second substrate comprising a common electrode, wherein the common electrode comprises: a first sub electrode comprising a first main trunk portion and a plurality of first branch portions, one end of all the first branch portions being connected to the first main trunk portion, the first branch portions corresponding to the (2k+1)th row of pixel electrodes in the pixel electrode matrix; and a second sub electrode opposite to the first sub electrode, the second sub electrode comprising a second main trunk portion and a plurality of second branch portions, one end of all the second branch portions being connected to the second main trunk portion, wherein the first branch portions and the second branch portions are spaced apart and alternatively disposed, and the second branch portions correspond to the (2k)th row of the pixel electrodes in the pixel electrode matrix, where k>0, and wherein the first branch portions and the second branch portions are parallel to each other; wherein image data inputted to the liquid crystal display comprises at least two image frames; wherein when one of the image frames is displayed, the (2k+1)th row of the pixel electrodes have the same polarity, the (2k)th row of the pixel electrodes have the same polarity, and the polarities of the (2k+1)th row of the pixel electrodes opposite to that of the (2k)th row of the pixel electrodes; wherein when two adjacent image frames are displayed, the polarities of each row of the pixel electrodes for the former frame opposite to that of corresponding row of the pixel electrodes for the later frame.

In the liquid crystal display panel of the present invention, the polarity of the pixel electrode comprises positive polarity and negative polarity, and the voltage inputted to the first sub electrode is different from the voltage inputted to the second sub electrode, and wherein when the voltage inputted to the first sub electrode is less than the voltage inputted the second sub electrode, the first sub electrode corresponds to the pixel electrodes having the positive polarities and the second sub electrode corresponds to the pixel electrodes having the negative polarities.

In the liquid crystal display panel of the present invention, the polarity of the pixel electrode comprises positive polarity and negative polarity, and the voltage inputted to the first sub electrode is different from the voltage inputted to the second sub electrode, and wherein when the voltage inputted to the first sub electrode is greater than the voltage inputted the second sub electrode, the second sub electrode corresponds to the pixel electrodes having the positive polarities and the first sub electrode corresponds to the pixel electrodes having the negative polarities.

The embodiments of the present invention provides a liquid crystal display panel, comprising: a first substrate comprising data lines, scan lines, and a pixel electrode matrix defined by the data lines and the scan lines; and a second substrate comprising a common electrode, wherein the common electrode comprises: a first sub electrode comprising a first main trunk portion and a plurality of first branch portions, one end of all the first branch portions being connected to the first main trunk portion, the first branch portions corresponding to the (2k+1)th column of pixel electrodes in the pixel electrode matrix; and a second sub electrode opposite to the first sub electrode, the second sub electrode comprising a second main trunk portion and a plurality of second branch portions, one end of all the second branch portions being connected to the second main trunk portion, wherein the first branch portions and the second branch portions are spaced apart and alternatively disposed, and the second branch portions correspond to the (2k)th column of the pixel electrodes in the pixel electrode matrix, where k>0.

In the liquid crystal display panel of the present invention, the first branch portions and the second branch portions are parallel to each other.

In the liquid crystal display panel of the present invention, image data inputted to the liquid crystal display comprises at least two image frames; wherein when one of the image frames is displayed, the (2k+1)th column of the pixel electrodes have the same polarity, the (2k)th column of the pixel electrodes have the same polarity, and the polarities of the (2k+1)th column of the pixel electrodes opposite to that of the (2k)th column of the pixel electrodes; and wherein when two adjacent image frames are displayed, the polarities of each column of the pixel electrodes for the former frame opposite to that of corresponding column of the pixel electrodes for the later frame.

In the liquid crystal display panel of the present invention, the polarity of the pixel electrode comprises positive polarity and negative polarity, and the voltage inputted to the first sub electrode is different from the voltage inputted to the second sub electrode, and wherein when the voltage inputted to the first sub electrode is less than the voltage inputted the second sub electrode, the first sub electrode corresponds to the pixel electrodes having the positive polarities and the second sub electrode corresponds to the pixel electrodes having the negative polarities.

In the liquid crystal display panel of the present invention, the polarity of the pixel electrode comprises positive polarity and negative polarity, and the voltage inputted to the first sub electrode is different from the voltage inputted to the second sub electrode, and wherein when the voltage inputted to the first sub electrode is greater than the voltage inputted the second sub electrode, the second sub electrode corresponds to the pixel electrodes having the positive polarities and the first sub electrode corresponds to the pixel electrodes having the negative polarities.

In the liquid crystal display panel of the present invention, the first substrate is an array substrate and the second substrate is a color filter substrate.

The embodiments of the present invention provides a liquid crystal display device, comprising: a backlight module and a liquid crystal display panel, wherein the liquid crystal display panel comprises: a first substrate comprising data lines, scan lines, and a pixel electrode matrix defined by the data lines and the scan lines; and a second substrate comprising a common electrode, wherein the common electrode comprises: a first sub electrode comprising a first main trunk portion and a plurality of first branch portions, one end of all the first branch portions being connected to the first main trunk portion, the first branch portions corresponding to the (2k+1)th row of pixel electrodes in the pixel electrode matrix;

and a second sub electrode opposite to the first sub electrode, the second sub electrode comprising a second main trunk portion and a plurality of second branch portions, one end of all the second branch portions being connected to the second main trunk portion, wherein the first branch portions and the second branch portions are spaced apart and alternatively disposed, and the second branch portions correspond to the (2k)th row of the pixel electrodes in the pixel electrode matrix, where k>0.

In the liquid crystal display device of the present invention, the first branch portions and the second branch portions are parallel to each other.

In the liquid crystal display device of the present invention, the polarity of the pixel electrode comprises positive polarity and negative polarity, and the voltage inputted to the first sub electrode is different from the voltage inputted to the second sub electrode, and wherein when the voltage inputted to the first sub electrode is less than the voltage inputted the second sub electrode, the first sub electrode corresponds to the pixel electrodes having the positive polarities and the second sub electrode corresponds to the pixel electrodes having the negative polarities.

In the liquid crystal display device of the present invention, the polarity of the pixel electrode comprises positive polarity and negative polarity, and the voltage inputted to the first sub electrode is different from the voltage inputted to the second sub electrode, and wherein when the voltage inputted to the first sub electrode is greater than the voltage inputted the second sub electrode, the second sub electrode corresponds to the pixel electrodes having the positive polarities and the first sub electrode corresponds to the pixel electrodes having the negative polarities.

In the liquid crystal display device of the present invention, image data inputted to the liquid crystal display comprises at least two image frames; wherein when one of the image frames is displayed, the (2k+1)th row of the pixel electrodes have the same polarity, the (2k)th row of the pixel electrodes have the same polarity, and the polarities of the (2k+1)th row of the pixel electrodes opposite to that of the (2k)th row of the pixel electrodes; and wherein when two adjacent image frames are displayed, the polarities of each row of the pixel electrodes for the former frame opposite to that of corresponding row of the pixel electrodes for the later frame.

In the liquid crystal display device of the present invention, the first substrate is an array substrate and the second substrate is a color filter substrate.

By fabricating the two individual sub electrodes on the entire common electrode and applying with different voltages, the liquid crystal display panel and the liquid crystal display device of the present invention solves the problem of the voltage of the pixel electrode required to be increased in the conventional display panels, thereby reducing the power consumption.

To make above content of the present invention more easily understood, it will be described in details by using preferred embodiments in conjunction with the appending drawings.

### BRIEF DESCRIPTION OF THE DRAWINGS

FIG. 1 is a schematic structural diagram showing a common electrode of a liquid crystal display panel in conventional skills.

FIG. 2 is a schematic structural diagram showing a common electrode of a liquid crystal display panel in accordance with a first embodiment of the present invention.

FIG. 3 is a schematic structural diagram showing pixel electrodes for the (n)th image frame in accordance with the liquid crystal display panel of the first embodiment of the present invention.

FIG. 4 is a schematic structural diagram showing pixel electrodes for the (n+1)th image frame in accordance with the liquid crystal display panel of the first embodiment of the present invention.

FIG. 5 is a schematic structural diagram showing a common electrode of a liquid crystal display panel in accordance with a second embodiment of the present invention.

FIG. 6 is a schematic structural diagram showing pixel electrodes for the (n)th image frame in accordance with the liquid crystal display panel of the second embodiment of the present invention.

FIG. 7 is a schematic structural diagram showing pixel electrodes for the (n+1)th image frame in accordance with the liquid crystal display panel of the second embodiment of the present invention.

### DETAILED DESCRIPTION OF THE PREFERRED EMBODIMENTS

The following descriptions for the respective embodiments are specific embodiments capable of being implemented for illustrations of the present invention with referring to the appended drawings. In the descriptions of the present invention, spatially relative terms, such as “upper”, “lower”, “front”, “back”, “left”, “right”, “inner”, “outer”, “lateral”, and the like, may be used herein for ease of description as illustrated in the drawings. Therefore, it will be understood that the spatially relative terms are intended to illustrate for understanding the present invention, but not to limit the present invention.

In the drawings, units with similar structures are represented by the same reference numbers.

Please refer to FIG. 2, which is a schematic structural diagram showing a common electrode of a liquid crystal display panel in accordance with a first embodiment of the present invention.

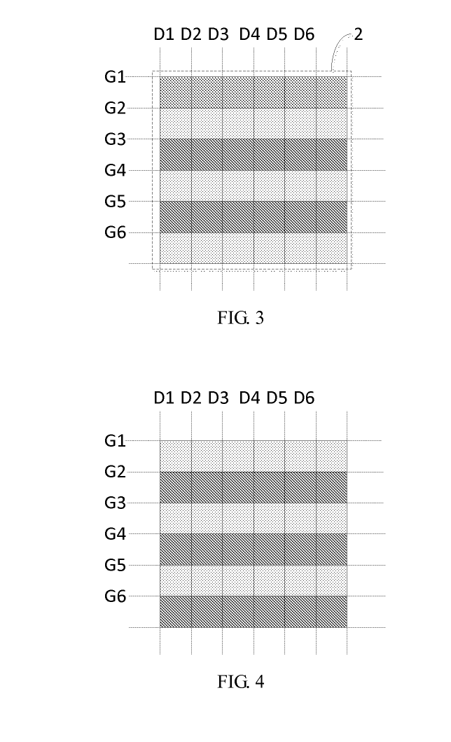

The liquid crystal display panel of the present invention comprises a first substrate, a second substrate, a liquid crystal layer located between the first substrate and the second substrate. In accompany with FIG. 3, the first substrate comprises data lines (D1-D6), scan lines (G1-G6), and a pixel electrode matrix 2 (as shown in a box drawn by dash lines in FIG. 2) defined by the data lines and the scan lines. The second substrate comprises a common electrode. The first substrate is an array substrate, for example. The second substrate is a color filter substrate, for example.

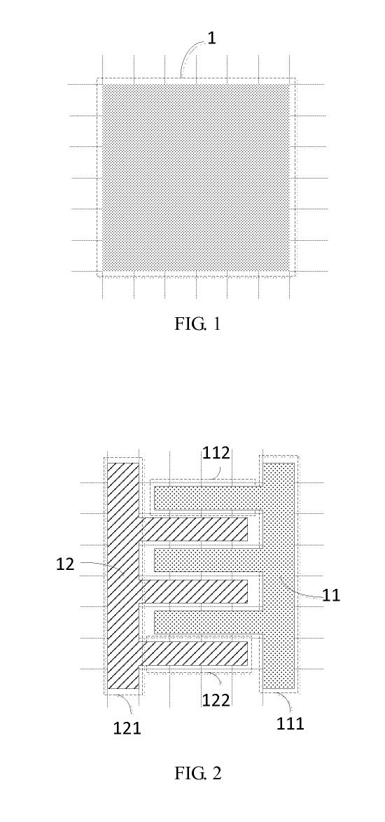

The structure of a conventional common electrode 1 is shown in FIG. 1 (i.e., the gray area), and is a block of transparent conductive layer. However, as shown in FIG. 2, the common electrode of the present invention comprises a first sub electrode 11 and a second sub electrode 12. The two electrodes are individually driven but are not electrically connected.

The first sub electrode 11 comprises a first main trunk portion 111 and a plurality of first branch portions 112. One end of all the first branch portions 112 is connected to the first main trunk portion 111. In accompany with FIG. 3, the first branch portions 112 correspond to the (2k+1)th row of the pixel electrodes in the pixel electrode matrix, where k>0.

The second sub electrode 12 opposites to the first sub electrode 11. The second sub electrode 12 comprises a second main trunk portion 121 and a plurality of second branch portions 122. One end of all the second branch portions 122 is connected to the second main trunk portion 121. The first branch portions 112 and the second branch portions 122 are spaced apart and alternatively disposed. In accompany with FIG. 3, the second branch portions 122 correspond to the (2k)th row or the (2k)th column of the pixel electrodes in the pixel electrode matrix.

Preferably, the first branch portions and the second branch portions are parallel to each other such that more powerful electric field is formed between the pixel electrodes and the common electrode. This benefits the twisting of liquid crystal, thereby improving the display effect.

Preferably, the image data inputted to the liquid crystal display comprises at least two frames of images, for example, n frames. As shown in FIG. 3, when one frame of the images is displayed, the (2k+1)th row of the pixel electrodes have the same polarity (e.g., positive polarity indicated by a dark gray), the (2k)th row of the pixel electrodes have the same polarity (e.g., negative polarity indicated by a light gray), and the polarities of the (2k+1)th row of the pixel electrodes opposite to that of the (2k)th row of the pixel electrodes.

When two adjacent frames of the images are displayed, the polarities of each row of the pixel electrodes for the former frame (the (n)th frame) opposite to that of corresponding row of the pixel electrodes for the later frame (the (n+1)th frame).

It is assumed that the polarities of the pixel electrodes for the (n)th image frame are represented by FIG. 3, positive polarities are indicated by a dark gray, and negative polarities are indicated by a light gray. The polarities of the pixel electrodes for the (n+1)th image frame are represented by FIG. 4. Taking the first row for example in accompany with FIG. 3 and FIG. 4, the polarities of the first row of the pixel electrodes are positive for the (n)th image frame while the polarities of the first row of the pixel electrodes are negative for the (n+1)th image frame. The other rows of the pixel electrodes have similar polarity changes.

The polarity of the pixel electrode comprises positive polarity and negative polarity. During driving the pixels, the voltage inputted to the first sub electrode is different from the voltage inputted to the second sub electrode. When the voltage inputted to the first sub electrode is less than the voltage inputted the second sub electrode, the first sub electrode corresponds to the pixel electrodes having the positive polarities and the second sub electrode corresponds to the pixel electrodes having the negative polarities. The first branch portions of the first sub electrode correspond to odd rows of the pixel electrodes and the second branch portions of the second sub electrode correspond to even rows of the pixel electrodes. Accordingly, as illustrated by FIG. 3, the polarities of the (2k+1)th row (i.e., an odd row) of the pixel electrodes are positive (e.g., the input voltage is 7V) and meanwhile the voltage inputted to the corresponding first sub electrode is 0V. The polarities of the (2k)th row (i.e., an even row) of the pixel electrodes are negative (e.g., the input voltage is 0V) and meanwhile the voltage inputted to the corresponding second sub electrode is 7V.

When the voltage inputted to the first sub electrode is greater than the voltage inputted the second sub electrode, the second sub electrode corresponds to the pixel electrodes having the positive polarities and the first sub electrode corresponds to the pixel electrodes having the negative polarities.

As illustrated by FIG. 4, the polarities of the (2k+1)th row (i.e., an odd row) of the pixel electrodes are negative and meanwhile the voltage inputted to the corresponding first sub electrode is 7V. The polarities of the (2k)th row (i.e., an even row) of the pixel electrodes are positive and meanwhile the voltage inputted to the corresponding second sub electrode is 0V.

The conventional common electrode is usually a block of transparent conductive layer. However, in the liquid crystal display panel of the present invention, two individual sub electrodes are obtained by fabricating a pattern on a block of common electrode and the two sub electrodes are inputted with different alternative voltages. When one of the sub electrodes is inputted with a voltage of 0V, the pixel electrodes corresponding thereto are inputted with a voltage of 7V. When the other sub electrode is inputted with a voltage of 7V, the pixel electrodes corresponding thereto are inputted with a voltage of 0V. Therefore, a constant voltage difference (e.g., 7V) between the pixel electrode and the common electrode is assured once the pixel electrode is inputted with an alternative voltage of 0 to 7V. The pixel electrode does not have to be inputted with a voltage of 0 to 14V that is adopted in the conventional skills. That is, the voltage inputted to the pixel electrode is decreased in magnitude, thereby reducing the power consumption.

By fabricating the two individual sub electrodes on the entire common electrode and applying with different voltages, the liquid crystal display panel of the present invention solves the problem of the voltage of the pixel electrode required to be increased in the conventional skills, thereby reducing the power consumption.

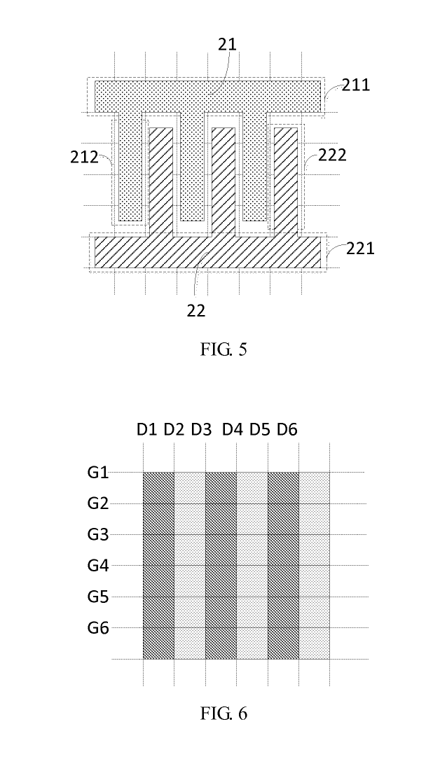

Please refer to FIG. 5, which is a schematic structural diagram showing a common electrode of a liquid crystal display panel in accordance with a second embodiment of the present invention.

The difference between the present embodiment and the first embodiment is that the two sub electrodes of the common electrode correspond to columns of the pixel electrodes in the present embodiment, rather than rows of the pixel electrodes.

As shown in FIG. 5, the common electrode comprises a first sub electrode 21 and a second sub electrode 22. The two electrodes are individually driven but are not electrically connected.

The first sub electrode 21 comprises a first main trunk portion 211 and a plurality of first branch portions 212. One end of all the first branch portions 212 is connected to the first main trunk portion 211. The first branch portions 212 correspond to the (2k+1)th column of the pixel electrodes in the pixel electrode matrix.

The second sub electrode 22 opposites to the first sub electrode 21. The second sub electrode 22 comprises a second main trunk portion 221 and a plurality of second branch portions 222. One end of all the second branch portions 222 is connected to the second main trunk portion 221. The first branch portions 212 and the second branch portions 222 are spaced apart and alternatively disposed. The second branch portions 222 correspond to the (2k)th column of the pixel electrodes in the pixel electrode matrix, where k>0.

The image data inputted to the liquid crystal display comprises at least two frames of images. As shown in FIG. 6, when one frame of the images is displayed, the (2k+1)th column of the pixel electrodes have the same polarity, the (2k)th column of the pixel electrodes have the same polarity, and the polarities of the (2k+1)th column of the pixel electrodes opposite to that of the (2k)th column of the pixel electrodes. When two adjacent frames of the images are displayed, the polarities of each column of the pixel electrodes for the former frame opposite to that of corresponding column of the pixel electrodes for the later frame.

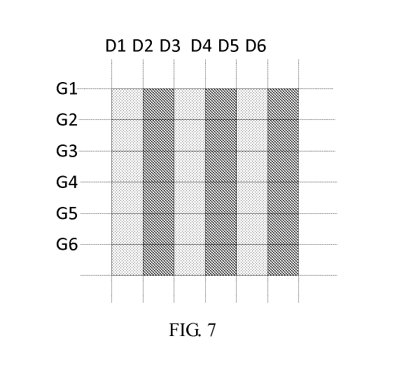

It is assumed that the polarities of the pixel electrodes for the (n)th image frame are represented by FIG. 6, positive polarities are indicated by a dark gray, and negative polarities are indicated by a light gray. The polarities of the pixel electrodes for the (n+1)th image frame are represented by FIG. 7. Taking the first column for example in accompany with FIG. 6 and FIG. 7, the polarities of the first column of the pixel electrodes are positive for the (n)th image frame while the polarities of the first column of the pixel electrodes are negative for the (n+1)th image frame. The other columns of the pixel electrodes have similar polarity changes.

The polarity of the pixel electrode comprises positive polarity and negative polarity. During driving the pixels, the voltage inputted to the first sub electrode is different from the voltage inputted to the second sub electrode. When the voltage inputted to the first sub electrode is less than the voltage inputted the second sub electrode, the first sub electrode corresponds to the pixel electrodes having the positive polarities and the second sub electrode corresponds to the pixel electrodes having the negative polarities. The first branch portions of the first sub electrode correspond to odd columns of the pixel electrodes and the second branch portions of the second sub electrode correspond to even columns of the pixel electrodes. Accordingly, as illustrated by FIG. 6, the polarities of the (2k+1)th column (i.e., an odd column) of the pixel electrodes are positive (e.g., the input voltage is 7V) and meanwhile the voltage inputted to the corresponding first sub electrode is 0V. The polarities of the (2k)th column (i.e., an even column) of the pixel electrodes are negative (e.g., the input voltage is 0V) and meanwhile the voltage inputted to the corresponding second sub electrode is 7V.

When the voltage inputted to the first sub electrode is greater than the voltage inputted the second sub electrode, the second sub electrode corresponds to the pixel electrodes having the positive polarities and the first sub electrode corresponds to the pixel electrodes having the negative polarities.

As illustrated by FIG. 4, the polarities of the (2k+1)th column (i.e., an odd column) of the pixel electrodes are negative and meanwhile the voltage inputted to the corresponding first sub electrode is 7V. The polarities of the (2k)th column (i.e., an even column) of the pixel electrodes are positive and meanwhile the voltage inputted to the corresponding second sub electrode is 0V.

By fabricating the two individual sub electrodes on the entire common electrode and applying with different voltages, the liquid crystal display panel of the present invention solves the problem of the voltage of the pixel electrode required to be increased in the conventional skills, thereby reducing the power consumption.

The present invention further provides a liquid crystal display device, which comprises a backlight module and a liquid crystal panel. The liquid crystal panel comprises the following elements.

A first substrate comprises data lines, scan lines, and a pixel electrode matrix defined by the data lines and the scan lines.

A second substrate comprises a common electrode, which comprises the following elements.

A first sub electrode comprises a first main trunk portion and a plurality of first branch portions. One end of all the first branch portions is connected to the first main trunk portion. The first branch portions correspond to the (2k+1)th row or the (2k+1)th column of the pixel electrodes in the pixel electrode matrix.

A second sub electrode opposites to the first sub electrode. The second sub electrode comprises a second main trunk portion and a plurality of second branch portions. One end of all the second branch portions is connected to the second main trunk portion. The first branch portions and the second branch portions are spaced apart and alternatively disposed. The second branch portions correspond to the (2k)th row or the (2k)th column of the pixel electrodes in the pixel electrode matrix, where k>0.

The first branch portions and the second branch portions are parallel to each other.

The image data inputted to the liquid crystal display comprises at least two frames of images. When one frame of the images is displayed, the (2k+1)th row of the pixel electrodes have the same polarity, the (2k)th row of the pixel electrodes have the same polarity, and the polarities of the (2k+1)th row of the pixel electrodes opposite to that of the (2k)th row of the pixel electrodes.

When two adjacent frames of the images are displayed, the polarities of each row of the pixel electrodes for the former frame opposite to that of corresponding row of the pixel electrodes for the later frame.

The image data inputted to the liquid crystal display comprises at least two frames of images. When one frame of the images is displayed, the (2k+1)th column of the pixel electrodes have the same polarity, the (2k)th column of the pixel electrodes have the same polarity, and the polarities of the (2k+1)th column of the pixel electrodes opposite to that of the (2k)th column of the pixel electrodes.

When two adjacent frames of the images are displayed, the polarities of each column of the pixel electrodes for the former frame opposite to that of corresponding column of the pixel electrodes for the later frame.

The polarity of the pixel electrode comprises positive polarity and negative polarity. The voltage inputted to the first sub electrode is different from the voltage inputted to the second sub electrode. When the voltage inputted to the first sub electrode is less than the voltage inputted the second sub electrode, the first sub electrode corresponds to the pixel electrodes having the positive polarities and the second sub electrode corresponds to the pixel electrodes having the negative polarities.

The polarity of the pixel electrode comprises positive polarity and negative polarity. The voltage inputted to the first sub electrode is different from the voltage inputted to the second sub electrode. When the voltage inputted to the first sub electrode is greater than the voltage inputted the second sub electrode, the second sub electrode corresponds to the pixel electrodes having the positive polarities and the first sub electrode corresponds to the pixel electrodes having the negative polarities.

The liquid crystal display device of the present invention can adopt any one of the liquid crystal display panels. Since the liquid crystal display panels have been described above, they are not detailed herein.

By fabricating the two individual sub electrodes on the entire common electrode and applying with different voltages, the liquid crystal display device of the present invention solves the problem of the voltage of the pixel electrode required to be increased in the conventional skills, thereby reducing the power consumption.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined by the appended claims.

What is claimed is:

1. A liquid crystal display panel, comprising:
a first substrate comprising data lines, scan lines, and a pixel electrode matrix defined by the data lines and the scan lines; and
a second substrate comprising a common electrode, wherein the common electrode comprises:
a first sub electrode comprising a first main trunk portion and a plurality of first branch portions, one end of all the first branch portions being connected to the first main trunk portion, the first branch portions corresponding to the (2k+1)th row of pixel electrodes in the pixel electrode matrix; and
a second sub electrode opposite to the first sub electrode, the second sub electrode comprising a second main trunk portion and a plurality of second branch portions, one end of all the second branch portions being connected to the second main trunk portion, wherein the first branch portions and the second branch portions are spaced apart and alternatively disposed, and the second branch portions correspond to the (2k)th row of the pixel electrodes in the pixel electrode matrix, where k>0, and wherein the first branch portions and the second branch portions are parallel to each other;
wherein image data inputted to the liquid crystal display comprises at least two image frames;
wherein when one of the image frames is displayed, the (2k+1)th row of the pixel electrodes have the same polarity, the (2k)th row of the pixel electrodes have the same polarity, and the polarities of the (2k+1)th row of the pixel electrodes opposite to that of the (2k)th row of the pixel electrodes;
wherein when two adjacent image frames are displayed, the polarities of each row of the pixel electrodes for the former frame opposite to that of corresponding row of the pixel electrodes for the later frame.

2. The liquid crystal display panel according to claim 1, wherein the polarity of the pixel electrode comprises positive polarity and negative polarity, and the voltage inputted to the first sub electrode is different from the voltage inputted to the second sub electrode, and wherein when the voltage inputted to the first sub electrode is less than the voltage inputted the second sub electrode, the first sub electrode corresponds to the pixel electrodes having the positive polarities and the second sub electrode corresponds to the pixel electrodes having the negative polarities.

3. The liquid crystal display panel according to claim 1, wherein the polarity of the pixel electrode comprises positive polarity and negative polarity, and the voltage inputted to the first sub electrode is different from the voltage inputted to the second sub electrode, and wherein when the voltage inputted to the first sub electrode is greater than the voltage inputted the second sub electrode, the second sub electrode corresponds to the pixel electrodes having the positive polarities and the first sub electrode corresponds to the pixel electrodes having the negative polarities.

4. A liquid crystal display panel, comprising:
a first substrate comprising data lines, scan lines, and a pixel electrode matrix defined by the data lines and the scan lines; and
a second substrate comprising a common electrode, wherein the common electrode comprises:
a first sub electrode comprising a first main trunk portion and a plurality of first branch portions, one end of all the first branch portions being connected to the first main trunk portion, the first branch portions corresponding to the (2k+1)th column of pixel electrodes in the pixel electrode matrix; and
a second sub electrode opposite to the first sub electrode, the second sub electrode comprising a second main trunk portion and a plurality of second branch portions, one end of all the second branch portions being connected to the second main trunk portion, wherein the first branch portions and the second branch portions are spaced apart and alternatively disposed, and the second branch portions correspond to the (2k)th column of the pixel electrodes in the pixel electrode matrix, where k>0.

5. The liquid crystal display panel according to claim 4, wherein the first branch portions and the second branch portions are parallel to each other.

6. The liquid crystal display panel according to claim 4, wherein image data inputted to the liquid crystal display comprises at least two image frames;
wherein when one of the image frames is displayed, the (2k+1)th column of the pixel electrodes have the same polarity, the (2k)th column of the pixel electrodes have the same polarity, and the polarities of the (2k+1)th column of the pixel electrodes opposite to that of the (2k)th column of the pixel electrodes; and
wherein when two adjacent image frames are displayed, the polarities of each column of the pixel electrodes for the former frame opposite to that of corresponding column of the pixel electrodes for the later frame.

7. The liquid crystal display panel according to claim 4, wherein the polarity of the pixel electrode comprises positive polarity and negative polarity, and the voltage inputted to the first sub electrode is different from the voltage inputted to the second sub electrode, and wherein when the voltage inputted to the first sub electrode is less than the voltage inputted the second sub electrode, the first sub electrode corresponds to the pixel electrodes having the positive polarities and the second sub electrode corresponds to the pixel electrodes having the negative polarities.

8. The liquid crystal display panel according to claim 4, wherein the polarity of the pixel electrode comprises positive polarity and negative polarity, and the voltage inputted to the first sub electrode is different from the voltage inputted to the second sub electrode, and wherein when the voltage inputted to the first sub electrode is greater than the voltage inputted the second sub electrode, the second sub electrode corresponds to the pixel electrodes having the positive polarities and the first sub electrode corresponds to the pixel electrodes having the negative polarities.

9. The liquid crystal display panel according to claim 4, wherein the first substrate is an array substrate and the second substrate is a color filter substrate.

10. A liquid crystal display device, comprising:
a backlight module and a liquid crystal display panel, wherein the liquid crystal display panel comprises:
a first substrate comprising data lines, scan lines, and a pixel electrode matrix defined by the data lines and the scan lines; and
a second substrate comprising a common electrode, wherein the common electrode comprises:
a first sub electrode comprising a first main trunk portion and a plurality of first branch portions, one end of all the first branch portions being connected to the first main trunk portion, the first branch portions corresponding to the (2k+1)th row of pixel electrodes in the pixel electrode matrix; and
a second sub electrode opposite to the first sub electrode, the second sub electrode comprising a second main trunk portion and a plurality of second branch portions, one end of all the second branch portions being connected to the second main trunk portion, wherein the first branch portions and the second branch portions are spaced apart and alternatively disposed, and the second branch portions correspond to the (2k)th row of the pixel electrodes in the pixel electrode matrix, where k>0.

11. The liquid crystal display device according to claim 10, wherein the first branch portions and the second branch portions are parallel to each other.

12. The liquid crystal display device according to claim 10, wherein the polarity of the pixel electrode comprises positive polarity and negative polarity, and the voltage inputted to the first sub electrode is different from the voltage inputted to the second sub electrode, and wherein when the voltage inputted to the first sub electrode is less than the voltage inputted the second sub electrode, the first sub electrode corresponds to the pixel electrodes having the positive polarities and the second sub electrode corresponds to the pixel electrodes having the negative polarities.

13. The liquid crystal display device according to claim 10, wherein the polarity of the pixel electrode comprises positive polarity and negative polarity, and the voltage inputted to the first sub electrode is different from the voltage inputted to the second sub electrode, and wherein when the voltage inputted to the first sub electrode is greater than the voltage inputted the second sub electrode, the second sub electrode corresponds to the pixel electrodes having the positive polarities and the first sub electrode corresponds to the pixel electrodes having the negative polarities.

14. The liquid crystal display device according to claim 10, wherein image data inputted to the liquid crystal display comprises at least two image frames;
wherein when one of the image frames is displayed, the (2k+1)th row of the pixel electrodes have the same polarity, the (2k)th row of the pixel electrodes have the same polarity, and the polarities of the (2k+1)th row of the pixel electrodes opposite to that of the (2k)th row of the pixel electrodes; and
wherein when two adjacent image frames are displayed, the polarities of each row of the pixel electrodes for the former frame opposite to that of corresponding row of the pixel electrodes for the later frame.

15. The liquid crystal display device according to claim 10, wherein the first substrate is an array substrate and the second substrate is a color filter substrate.
